(19) United States
(12) Patent Application Publication
(10) Pub. No.: US 2008/0245204 A1
(43) Pub. Date: Oct. 9, 2008

(54) Device for Cross-Cutting Webs of Fabric, in Particular Paper or Cardboard

(75) Inventor: Dirk Voessing, Willich (DE)

Correspondence Address: Muncy, Geissler, Olds & Lowe, PLLC, P.O. BOX 1364, FAIRFAX, VA, 22038-1364, US

(73) Assignee: BIELOMATIK JAGENBERG GMBH & CO. KG, NEUSS (DE)

(21) Appl. No.: 11/578,115

(22) PCT Filed: Mar. 26, 2005
(86) PCT No.: PCT/EP2005/003205

§ 371 Date: Jan. 22, 2008

(30) Foreign Application Priority Data
Apr. 8, 2004 (DE) 20 2004 005 827.8

(51) Int. Cl. B26D 7/00

(52) U.S. Cl. 83/401

(57) ABSTRACT

Devices are known for crosscutting webs of paper or cardboard, which include a crosscutting device having two blade drums, which are provided with cross blades. Arranged behind the crosscutting device is a sheet transport device, which includes a braking device having a brake roller. To avoid markings on sheets of delicate paper or cardboard types, the brake roller of the present invention is comprised of a cylindrical base body, on which, at a peripheral distance from one another, radially extending ribs made of a elastic material are mounted, which terminate in a cylindrical enveloping surface, which is coaxial in relation to the base body.

### TECHNICAL FIELD

The invention relates to a device for cross-cutting webs of material, in particular webs of paper or cardboard, comprised of a crosscutting device having of two blade drums that are provided with cross blades, and a sheet transport device arranged behind the crosscutting device, which includes a braking device comprising a brake roller.

### STATE OF THE ART

Crosscutting devices, which by crosscutting produce individual sheets from a web of paper or cardboard, which are subsequently piled up in a stack, are known to have a sheet transport device behind the crosscutting device, which includes a braking device with freely rotating brake rollers. If a sheet is decelerated, the leading edge of the not yet decelerated subsequent sheet pushes over its rear edge. In this way, a shingle stream of staggered sheets is generated, which thereafter is deposited on a stack by a stacking unit. A crosscutting device of this class is described in DE 199 45 114-A.

The deceleration of a fast-running sheet is thereby accomplished by the brake rollers exerting pressure on the preceding and thus already decelerated and slower sheet. During this relative movement in the braking process between the two sheets, markings can develop on the surface of the slower sheet when delicate types of paper or cardboard are being processed.

### ILLUSTRATION OF THE INVENTION

It is therefore an object of the invention to improve a crosscutting device of this class such that markings on the sheets are avoided, even on delicate types of paper or cardboard.

This objective is met such that the brake roller(s) is/are elastically seated and can be moved upwards by the force of an incoming sheet.

The elastic seating of the brake rollers makes it possible to precisely meter out the force of the contact pressure that is necessary to decelerate the sheets. The brake rollers can give way upwardly, thus adjusting their position to the staggered progression of the top side of the shingled sheets, or stacks of sheets, passing through. The nip force in the seizing nip between the brake rollers and the lower conveyor, on which the sheets are positioned, that affects the sheets or stacks of sheets, remains essentially constant during passage.

The dependent claims include preferred embodiments of special benefit of a brake roller of the present invention:

As a result of the individual seating of the rollers according to claim 2, no negative sagging influences occur.

The features of claims 3 and 4 make it possible to adjust the total pressure in the seizing nip.

The features of claims 5, 6, 8, and 9, individually and in combination, serve to create as large a contact surface as possible between the brake rollers and the sheets. A large diameter of the brake rollers according to claim 7 makes for a beneficial horizontal entry into the seizing nip.

The lightweight construction of the brake rollers according to claims 9 and 10 beneficially avoids their mass inertia.

### BRIEF DESCRIPTION OF THE DRAWING

The drawing aids in describing the invention in more detail with a simplified illustration of an exemplary embodiment.

Shown in

FIG. 1 is a side view of a crosscutting device;

FIG. 2 is an enlarged section of the braking and overlapping device;

FIG. 3 is an enlarged top view of the braking device with the brake rollers;

FIG. 4 is a cross section of a brake roller and the seating thereof.

### EMBODIMENTS OF THE INVENTION

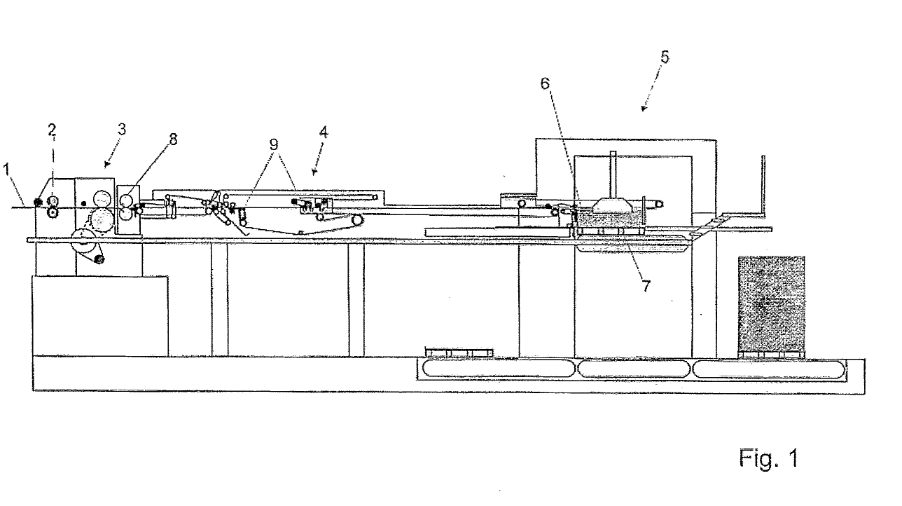

The device illustrated in FIG. 1 in an overall view is used in the production of sheets of paper or cardboard from a continuously incoming web 1. In the direction of the web/sheet conveyance (from left to right in the figures), the following components are arranged consecutively:

A device for longitudinal cutting 2, where the edges of web 1 are trimmed and, if need be, web 1 is divided into up to six individual webs, a crosscutting device 3, a sheet transport device 4, which takes over and decelerates the sheets produced during crosscutting, whereby a shingle stream is generated, and a stacking unit 5, in which the sheets are deposited onto stacks 6, which are positioned on pallets 7.

The crosscutting device 3 comprises in a known manner two superimposed blade drums 8, each of which is provided with at least one cross blade, which divide web 1 into sheets during passage. If a plurality of superimposed webs 1 is processed, sheet packets are generated during crosscutting, which are subsequently passed on.

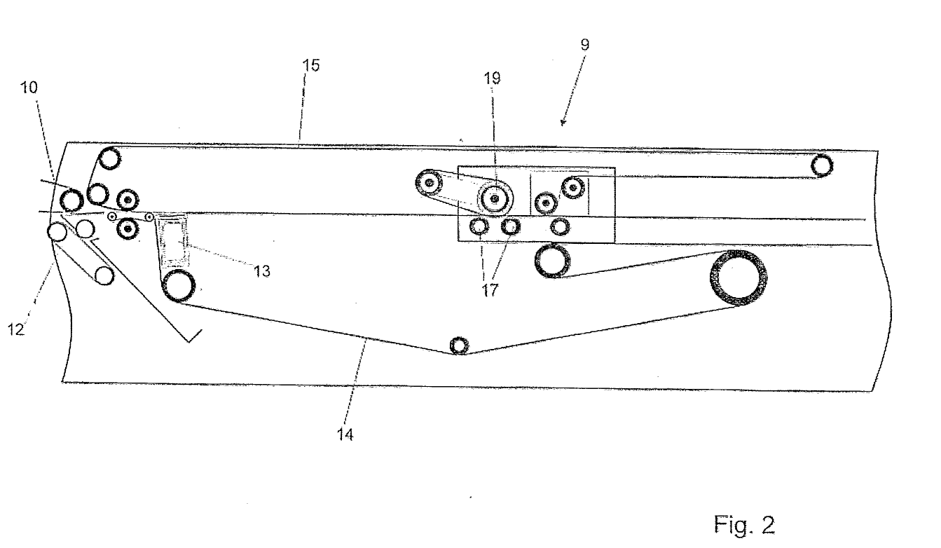

Arranged directly behind the crosscutting device 3 is the sheet transport device 4, the discharge side of which is shown in an enlarged illustration in FIG. 2. It includes elements for engaging the leading edge of the web generated by a cross cut and for tightening the web during crosscutting, for accelerated conveyance of the sheet generated by a crosscut, to generate a gap between two sheets, and a braking device 9 for decelerating a sheet to generate a shingle stream from overlapping sheets, which is conveyed to the stacking unit 5 at a decelerated transport speed.

The sheet transport device 4 starts with a speedily rotating upper belt conveyor 10 and an associated lower fast belt conveyor 11, which are constructed of individual parallel belts and are driven at an increased speed as compared to the speed of the incoming web 1. Thus, a sheet produced during crosscutting is moved along at an increased speed.

Starting behind a sheet gate 12 is the braking and overlapping device 9 having a suction box 13 that can be subjected to low pressure, the upper wall of which is provided with suction openings and extends parallel at some distance below the conveying plane. Due to the low pressure, the rear edges of the sheets are drawn in, and are diverted downwards. The rear edges of the sheets are thereby detached from a high-speed upper belt conveyor 15, which extends along the length of the braking and overlapping device 9. At the suction box 13, a lower belt conveyor 14 commences, which runs at the slower depositing speed, at which the sheets are deposited onto stack 6. During deceleration of a sheet, the leading edge of a subsequent sheet still moving at a faster speed slides over its rear edge. In this way, a shingle stream of overlapping sheets is generated, which is moved along by the lower belt conveyor 14 at the slower depositing speed.

In order to push the sheets from the high-speed upper belts 15 downwards onto the slow belt conveyor 14 and to decelerate the sheets, a plurality of brake rollers 19, each of which is seated in a freely rotatable manner, are arranged at a distance behind the suction box 13 transversely across the operating width, whereby the rotational axes extend horizontally and transversely to the running direction of the sheets and are essentially flush with one another. The brake rollers 19 are arranged at an axial distance to one another between two respective upper belts 14, and in their periphery, extend beyond them downwards. In this way, together with the lower conveyor belt 14, they form a seizing nip, which the sheets enter with their leading edges. In the area of the brake rollers 19, the lower conveyor belt 14 is supported by support rollers 17 to make it possible to exert the required contact pressure on the sheets for deceleration.

In FIG. 4, a brake roller 19 and its seating is illustrated in an enlarged cross section:

Each brake roller 19 is comprised of a base body 20 in the form of a hollow cylinder, which preferably is made of lightweight metal, for example, aluminum. Preferably, a layer of an elastically ductile material is mounted to the base body 20 as a shell so that as large a contact surface as possible is generated when the brake roller 19 is pressed against the sheets. Preferably, the shell layer is made of a cellular elastomer made by foaming, in particular polyurethane.

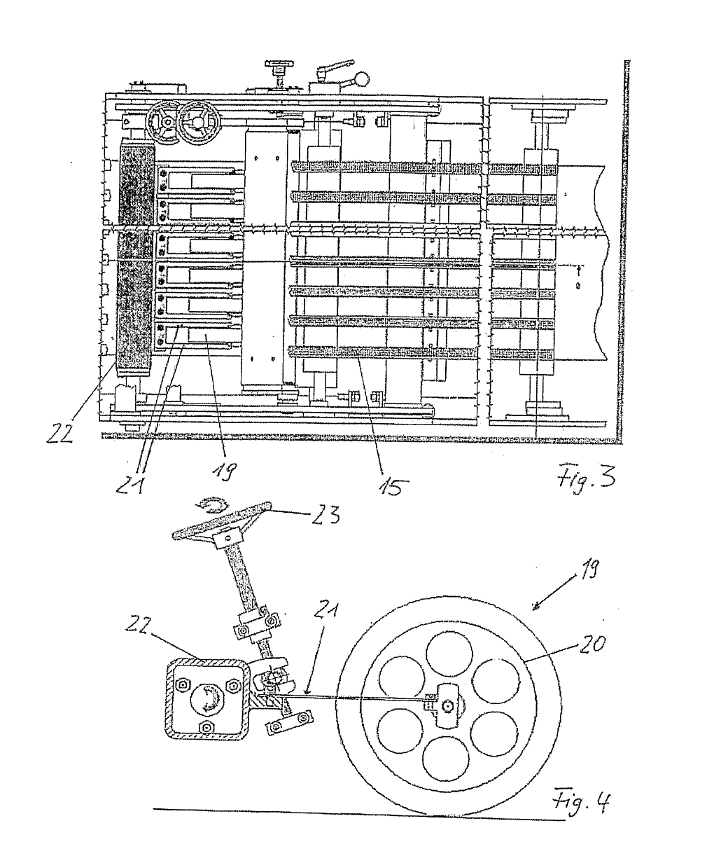

The brake rollers 19 have an outer diameter of between 50 mm and 350 mm, preferably between 150 mm and 250 mm. Their width as measured in the direction of their rotational axis is 20 mm to 200 mm, preferably 20 mm to 100 mm. In their width, they are constructed such, and are arranged diagonally across the operational width such that the sum of the roller widths is more than 25 percent, preferably more than 50 percent, of the operational width of the device, as is illustrated in FIG. 3. In this way, a sufficiently large contact surface with the sheets is ensured.

It is essential for the invention that each brake roller 19, preferably each brake roller 19 individually, is elastically seated, and can be moved upwards by the force of an incoming sheet. In a particularly beneficial version of the exemplary embodiment, each brake roller 19 is seated on two laterally mounted leaf springs 21, which at their other end are attached to a traverse member 22. The traverse member 22 is pivotably mounted in the machine frame around its longitudinal axis, which extends horizontally and transversely to the running direction of the sheets, whereby the angle position can be very precisely tuned and fixed in place by a swivel drive, which in the present example is a hand wheel 23. By adjusting the swivel angle, the elastic force of the bearings of the brake rollers 19 can be adjusted, and thus the pressure force in the seizing nip. This allows an adaptation to various web materials, for example, types of paper, which are prone to markings at varying degrees.

Beneficially, the upstroke of the vertical movement of the brake rollers 19 can be adjustably limited so that the maximum end width of the seizing nip cannot get unduly big. In addition, each brake roller 19 can be individually lifted and put in an inactive position in the event that in its area, a longitudinal cut in web 1 is taking place. For further improved adjustability, the conveyor belts abutting to the sheets in brake device 9 are slidably mounted.

As previously described, the brake rollers 19 are of lightweight construction and have a specific weight of less than 500 kg/m³, preferably of less than 300 kg/m³. Thus, they beneficially have a low mass inertia, and can be pushed upwards by the force of an incoming sheet.

During the deceleration of a sheet, the effective peripheral speed of the brake rollers 19 is reduced to nearly the conveying speed of the lower, slower sheet, which is conveyed positioned on the lower belt conveyor 14. The deceleration is thereby so slow and without pressure peaks that markings in the area of the leading edges of the sheets are avoided.

1. A device for crosscutting webs of material, in particular webs of paper or cardboard, the device comprising:
a crosscutting device having two blade drums provided with cross blades; and
a sheet transport device, which is arranged behind the crosscutting devices that includes at least one freewheeling brake roller
wherein the brake roller is elastically seated and is moved upwards by a force of an incoming sheet.

2. The device according to claim 1, wherein across an operating width of the device, a row of brake rollers that are spaced at intervals, are individually elastically seated.

3. The device according to claim 1, wherein bearings of the brake roller, individually or jointly, are pivotable around an axis, which extends horizontally crosswise to a direction of a sheet conveyance, to adjust the spring tension.

4. Device according to claim 3, wherein the brake roller is elastically seated in a pivotable traverse member, preferably on leaf springs.

5. The device according to claim 1, wherein the brake roller includes a rigid cylindrical base body, onto which an elastically ductile shell is mounted.

6. The device according to claim 2, wherein, in their width as measured in the direction of the axis of rotation, the brake rollers are formed and arranged such that the sum of the roller widths is more than 25 percent, preferably more than 50 percent, of the operating width of the device.

7. The device according to claim 1, wherein the outer diameter of the brake roller is 50 mm to 350 mm, preferably 150 mm to 250 mm.

8. The device according to claim 1, wherein the width of the brake roller Has measured in the direction of its rotational axis is 20 mm to 200 mm, preferably 20 mm to 100 mm.

9. The device according to claim 1, wherein the brake rollers are of lightweight construction with a specific weight of less than 500 kg/m³, preferably less than 300 kg/m³.

10. The device according to claim 1, wherein the brake rollers have a base body made of lightweight metal, said base body being a hollow cylinder.
